(19) United States
(12) Patent Application Publication
(10) Pub. No.: US 2023/0202459 A1
(43) Pub. Date: Jun. 29, 2023

(54) CONTROLLER FOR HYBRID ELECTRIC VEHICLE AND CONTROL METHOD FOR HYBRID ELECTRIC VEHICLE

(71) Applicant: TOYOTA JIDOSHA KABUSHIKI KAISHA, Aichi-ken (JP)

(72) Inventor: Atsushi FUKUDA, Nisshin-shi (JP)

(21) Appl. No.: 18/058,772

(22) Filed: Nov. 25, 2022

(30) Foreign Application Priority Data
Dec. 24, 2021 (JP) 2021-210625

(51) Int. Cl. B60W 20/40; B60W 10/02; B60W 10/08; B60W 10/06

(52) U.S. Cl. CPC B60W 20/40; B60W 10/02; B60W 10/08; B60W 10/06; B60W 2510/06; B60W 2710/027; B60W 2510/0638

(57) ABSTRACT

The hybrid electric vehicle has a first traveling mode in which the clutch is engaged and the engine is operating, and a second traveling mode in which the clutch is disengaged and the engine is stopped. When switching from the first traveling mode to the second traveling mode, the controller for the hybrid electric vehicle performs the torque replacement control and then disengages the clutch. During the torque replacement control, the controller causes the variable valve mechanism provided in the engine to change the valve timing at a smaller change rate than during a normal engine control.

### RELATED APPLICATION

The present application claims priority of Japanese Patent Application No. 2021-210625 filed on Dec. 24, 2021, the disclosure of which is hereby incorporated by reference herein in its entirety.

### BACKGROUND

### 1. Field

The present disclosure relates to a controller for a hybrid electric vehicle having two types of drive sources, an engine and a motor generator. The present disclosure further relates to a control method for the hybrid electric vehicle.

### 2. Description of Related Art

Japanese Laid-Open Patent Publication No. 2007-83796 discloses a controller mounted on a hybrid electric vehicle having two types of drive sources, an engine and a motor generator. The hybrid electric vehicle includes a motor generator connected to wheels, and an engine connected to the motor generator via a clutch. Such a hybrid electric vehicle has a hybrid traveling mode and a battery electric vehicle (BEV) traveling mode. The hybrid traveling mode is a mode in which the clutch is engaged and the vehicle travels using the power of the engine. The BEV traveling mode is a mode in which the engine is stopped, the clutch is disengaged, and the vehicle is driven by the power of the motor generator. As described in the above patent document, when switching from the hybrid traveling mode to the BEV traveling mode, a torque change occurs as the engine is stopped or the clutch is disengaged. The above patent document describes that the torque change is compensated by the torque of the motor generator.

The hybrid electric vehicle may include an engine that includes a variable valve mechanism that variably sets the valve timings of the intake valve and the exhaust valve. In a hybrid electric vehicle equipped with an engine having the variable valve mechanism, it is difficult to accurately predict the torque change described above. Thus, there is a possibility that the motor generator cannot perform torque compensation appropriately, resulting in torque fluctuation.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

According to one aspect of the present disclosure, a controller for a hybrid electric vehicle is provided. The hybrid electric vehicle includes an engine including a variable valve mechanism configured to variably set valve timing of an engine valve, a motor generator, a clutch configured to couple the engine to the motor generator, where the engine and the motor generator are driving sources for traveling, and the engine is configured to be connected to a wheel via the clutch and the motor generator. The controller includes processing circuitry. Traveling modes of the hybrid electric vehicle include a first traveling mode in which the hybrid electric vehicle travels with the clutch engaged and the engine operating, and a second traveling mode in which the hybrid electric vehicle travels with the clutch disengaged and the engine being stopped. The processing circuitry is configured to execute a torque replacement control that decreases a shaft torque of the engine to 0 and increases a torque of the motor generator in accordance with the decreased shaft torque when switching from the first traveling mode to the second traveling mode. The processing circuitry is configured to cause a change rate, at which the valve timing is changed by the variable valve mechanism to be smaller during the torque replacement control than during a normal engine control, and configured to disengage the clutch after executing the torque replacement control.

According to another aspect of the present disclosure, a control method for a hybrid electric vehicle is provided. The hybrid electric vehicle includes an engine including a variable valve mechanism configured to variably set valve timing of an engine valve, a motor generator, a clutch configured to couple the engine to the motor generator, where the engine and the motor generator are driving sources for traveling, and the engine is configured to be connected to a wheel via the clutch and the motor generator. Traveling modes of the hybrid electric vehicle include a first traveling mode in which the hybrid electric vehicle travels with the clutch engaged and the engine operating, and a second traveling mode in which the hybrid electric vehicle travels with the clutch disengaged and the engine being stopped. The control method includes: executing a torque replacement control that decreases a shaft torque of the engine to 0 and increases a torque of the motor generator in accordance with the decreased shaft torque when switching from the first traveling mode to the second traveling mode, causing a change rate, at which the valve timing is changed by the variable valve mechanism to be smaller during the torque replacement control than during a normal engine control, and disengaging the clutch after executing the torque replacement control.

Other features and aspects will be apparent from the following detailed description, the drawings, and the claims.

### BRIEF DESCRIPTION OF THE DRAWINGS

FIG. 1 is a diagram schematically showing the configuration of a drive system of a hybrid electric vehicle equipped with a controller according to one embodiment.

FIG. 2 is a diagram schematically showing the configuration of the controller.

FIG. 3 is a flowchart showing the processing procedure of the target VT setting routine executed by the controller.

FIG. 4 is a time chart showing changes in various values during the torque replacement control executed by the controller, where part (A) shows changes in an actual intake air amount KL and a required intake air amount KL*, part (B) shows changes in a base value VTEB and a gradual change value VTESM of a target exhaust valve timing, part (C) shows changes in a base value VTIB and a gradual change value VTISM of a target intake valve timing, and part (D) shows changes in a shaft torque TE of the engine and an MG torque TMG.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

An embodiment of a controller for a hybrid electric vehicle will be described in detail below with reference to the drawings.

### Configuration of Drive System of Hybrid Electric Vehicle 10

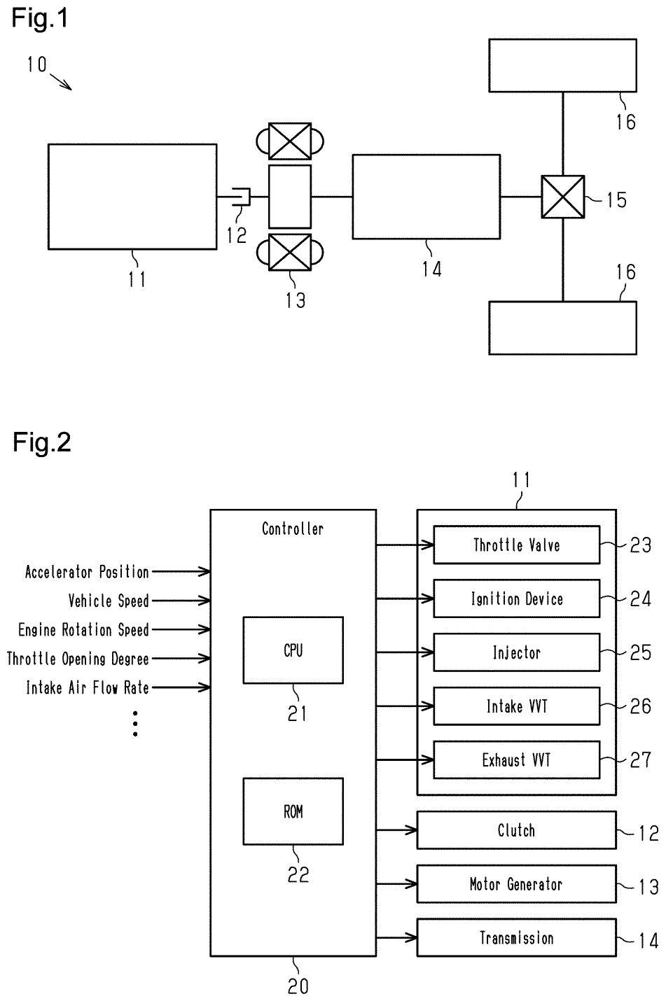

First, referring to FIG. 1, the configuration of the drive system of a hybrid electric vehicle 10 equipped with a controller 20 of the present embodiment will be described. As shown in FIG. 1, the hybrid electric vehicle 10 includes an engine 11 and a motor generator 13, which are driving sources for traveling. The motor generator 13 is connected to two wheels 16 via a transmission 14 and differential 15. Also, the motor generator 13 is connected to the engine 11 via a clutch 12. That is, the engine 11 is connected to wheels 16 via the clutch 12 and motor generator 13. In the hybrid electric vehicle 10, the engine 11 is disconnected from the wheels 16 when the clutch 12 is disengaged.

### Configuration of Controller 20

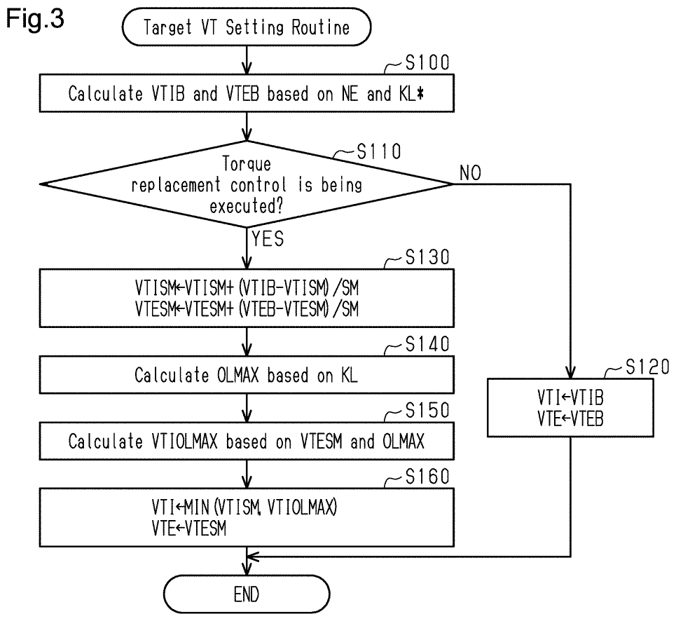

Next, referring to FIG. 2, the configuration of the controller 20 that controls the hybrid electric vehicle 10 will be described. As shown in FIG. 2, the controller 20 is configured as an electronic control unit including a CPU 21 and a ROM 22. The CPU 21 is a processing device that executes various processes for controlling the hybrid electric vehicle 10. The ROM 22 is a storage device that stores control programs and data. Detection signals from sensors provided at a plurality of locations on the hybrid electric vehicle 10 are input to the controller 20. Detection values corresponding to detection signals include values that indicate the traveling state of hybrid electric vehicle 10, such as an accelerator position and a vehicle speed. Also, the detected values include values indicating the operating state of the engine 11, such as an engine rotation speed, a throttle opening degree, and an intake air flow rate. The controller 20 controls the engine 11, the clutch 12, the motor generator 13, and the transmission 14 based on these detected values.

The engine 11 includes a throttle valve 23 that variably sets the flow path area of intake air, an ignition device 24 that ignites air-fuel mixture, and an injector 25 that injects fuel. The engine 11 also includes an intake valve and an exhaust valve, which are engine valves. The engine 11 includes an intake-side variable valve mechanism that variably sets the valve timing of the intake valve. The engine 11 includes an exhaust-side variable valve mechanism that variably sets the valve timing of the exhaust valve. In the following description, the valve timing of the intake valve is referred to as intake valve timing. Also, the valve timing of the exhaust valve is referred to as exhaust valve timing. In addition, the intake-side variable valve mechanism, which variably sets the intake valve timing, is referred to as an intake VVT 26. The exhaust-side variable valve mechanism, which variably sets the exhaust valve timing, is referred to as an exhaust VVT 27. The controller 20 controls the throttle opening degree, ignition timing, a fuel injection amount, intake valve timing, and exhaust valve timing. These are referred to as the control of the engine 11.

### Switching Traveling Modes

The hybrid electric vehicle 10 has a first traveling mode and a second traveling mode. The first traveling mode is a traveling mode in which the hybrid electric vehicle 10 travels with the clutch 12 engaged and the engine 11 operating. On the other hand, the second traveling mode is a traveling mode in which the hybrid electric vehicle 10 travels with the clutch 12 disengaged and the engine 11 being stopped. The controller 20 switches the traveling mode based on the amount of depression of the accelerator pedal and the state of charge of the onboard power source.

The controller 20 performs a torque replacement control when the controller 20 switches the traveling mode from the first traveling mode to the second traveling mode. The torque replacement control is a control that decreases the shaft torque of the engine 11 to 0 and increases the torque of the motor generator 13 in accordance with the decrease in the shaft torque. After the torque replacement control ends, the controller 20 disengages the clutch 12 and stops the engine 11, thereby shifting the traveling mode to the second traveling mode.

The controller 20 decreases the shaft torque during the torque replacement control. The shaft torque is decreased by decreasing the amount of intake air by decreasing the throttle opening degree and retarding the ignition timing. Specifically, in the torque replacement control, the controller 20 commands the throttle opening degree to decrease to the opener opening degree. The opener opening is the minimum value of the control range of the throttle opening degree while the engine 11 is traveling.

While the engine 11 is operating, the controller 20 estimates an actual intake air amount KL. The actual intake air amount KL is estimated based on the operating conditions of the engine 11 such as the throttle opening degree and the intake air flow rate. The actual intake air amount KL is the amount of fresh air used for combustion in the combustion chamber of the engine 11. During the torque replacement control, the controller 20 adjusts the ignition timing retard amount based on the estimated value of the actual intake air amount KL so that the shaft torque of the engine 11 decreases at a predetermined pace.

### Control of Valve Timing of Engine 11

As described above, the controller 20 controls the intake valve timing and the exhaust valve timing as part of the control of the engine 11. Specifically, the controller 20 sets target intake valve timing VTI and target exhaust valve timing VTE according to the operating conditions of the engine 11, respectively. The controller 20 then drives the intake VVT 26 so that the intake valve timing matches the target intake valve timing VTI. Also, the controller 20 drives the exhaust VVT 27 so that the exhaust valve timing matches the target exhaust valve timing VTE.

It should be noted that the intake valve timing in the following description represents the advance amount of the valve timing from the most retarded position, at which the valve timing is the most retarded within the control range. Further, the exhaust valve timing in the following description represents the advance amount of the valve timing from the most retarded position, where the valve timing is the most retarded within the control range.

FIG. 3 shows the processing procedure of the target VT setting routine executed by the controller 20. This sets the target intake valve timing VTI and the target exhaust valve timing VTE. The controller 20 repeatedly executes this routine at predetermined control cycles while the engine 11 is operating.

When this routine starts, the controller 20 first executes step S100. In step S100, the controller 20 calculates a base value VTIB of the target intake valve timing VTI and a base value VTEB of the target exhaust valve timing VTE based on the engine rotation speed NE and the required intake air amount KL*. During the torque replacement control, the value of the required intake air amount KL* is set to a predetermined idling intake air amount. Specifically, the base values VTIB and VTEB are respectively set so that the valve overlap amount of the intake valve and the exhaust valve becomes 0.

Subsequently, in step S110, the controller 20 determines whether the torque replacement control is being executed. If the torque replacement control is not being executed (step S110: NO), the controller 20 proceeds to step S120. In step S120, the controller 20 sets the target intake valve timing VTI and the target exhaust valve timing VTE to the base values VTIB and VTEB, respectively. Then, the controller 20 ends the processing of this routine.

If the torque replacement control is being executed (S110: YES), the controller 20 advances the process to step S130. Then, in step S130, the controller 20 calculates a gradual change value VTISM of the target intake valve timing VTI. The gradual change value VTISM is calculated by subjecting the base value VTIB to a gradual change process that suppresses changes in the value. Also, in step S130, the controller 20 calculates a gradual change value VTESM of the target exhaust valve timing VTE. The gradual change value VTESM is calculated by subjecting the base value VTEB to a similar gradual change process. In this embodiment, the moving average value of the base value VTIB calculated using expression (1) is calculated as the gradual change value VTISM. Similarly, the moving average value of the base value VTEB calculated using expression (2) is calculated as the gradual change value VTESM. The SM in expressions (1) and (2) is a constant that determines the degree of gradual change, and its value is set to a value greater than 1.

VTISM←VTISM+(VTIB−VTISM)/SM (1)

VTESM←VTESM+(VTEB−VTESM)/SM (2)

Next, the controller 20 calculates a maximum overlap amount OLMAX based on the estimated value of the actual intake air amount KL. The maximum overlap amount OLMAX represents the maximum value of the valve overlap amount that can avoid poor combustion with the current intake air amount of the engine 11. The maximum overlap amount OLMAX becomes smaller as the actual intake air amount KL decreases.

Furthermore, in step S150, the controller 20 calculates a guard value VTIOLMAX of the target intake valve timing VTI based on the gradual change value VTESM and the maximum overlap amount OLMAX. The guard value VTIOLMAX represents the intake valve timing at which the valve overlap amount becomes the maximum overlap amount OLMAX when the exhaust valve timing is set to the gradual change value VTESM.

Then, in subsequent step S160, the controller 20 sets the value of the target intake valve timing VTI to the smaller value of the gradual change value VTISM and the guard value VTIOLMAX. That is, the controller 20 sets the value of the target intake valve timing VTI to the retarded one of the values. Also, in step S160, the controller 20 sets the value of the target exhaust valve timing VTE to the value of the gradual change value VTESM. After that, the controller 20 ends the processing of this routine.

### Operation and Effects of Embodiment

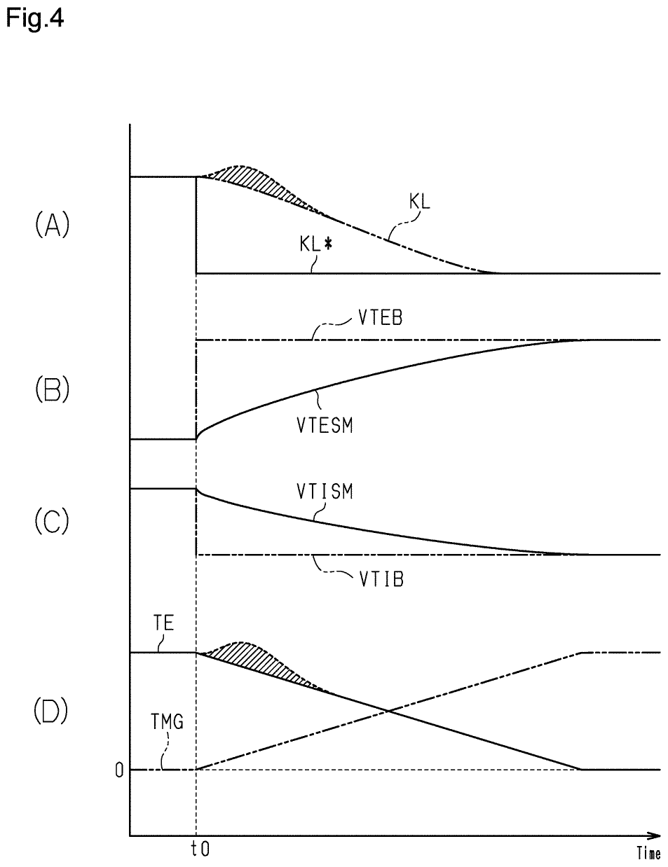

An example implementation of the torque replacement control is shown in FIG. 4. Part (A) in FIG. 4 shows changes in the actual intake air amount KL and the required intake air amount KL* during the torque replacement control. Part (B) in FIG. 4 shows changes in the base value VTEB and the gradual change value VTESM of the target exhaust valve timing during the torque replacement control. Part (C) in FIG. 4 shows changes in the base value VTIB and the gradual change value VTISM of the target intake valve timing VTI during the torque replacement control. Part (D) in FIG. 4 shows changes in a shaft torque TE of the engine 11 and an MG torque TMG during the torque replacement control. The MG torque TMG represents torque generated by the motor generator 13.

When starting the torque replacement control at time t0, the controller 20 decreases the required intake air amount KL* to the idling intake air amount as shown in part (A) of FIG. 4. As a result, a decrease in the throttle opening degree is commanded, and the actual intake air amount KL begins to decrease. Note that the decrease in the actual intake air amount KL progresses gradually over a certain amount of time due to the response delay in the operation of the throttle valve 23 and the transport of the intake air.

Further, after the torque replacement control is started, the controller 20 adjusts the ignition timing retard amount based on the estimated value of the actual intake air amount KL so that the shaft torque TE of the engine 11 decreases at a constant pace. The controller 20 increases the MG torque TMG by the amount of the decrease in the shaft torque TE, thereby suppressing fluctuations in the torque transmitted to the wheels 16. The controller 20 performs such torque replacement control until the shaft torque TE of the engine 11 becomes 0.

As shown in parts (B) and (C) in FIG. 4, at time t0 when the torque replacement control is started, multiple values change according to the change in the required intake air amount KL*. Specifically, the base values VTIB and VTEB of the target intake valve timing VTI and the target exhaust valve timing VTE change. If the actual intake air amount KL decreases to the idling intake air amount while the valve overlap amount remains large, there is a possibility that the ratio of the internal EGR gas to the air-fuel mixture will become too high. As a result, combustion failure such as misfire may occur. Thus, in this embodiment, the base values VTIB and VTEB are changed so that the valve overlap amount becomes 0 at time t0 when the torque replacement control is started. When the valve timing changes, the effect of the change is immediately reflected in the actual intake air amount KL. Unlike the present embodiment, if the target intake valve timing VTI and the target exhaust valve timing VTE are set to the changed base values VTIB and VTEB, the actual intake air amount KL changes abruptly. As a result, the estimated value of the actual intake air amount KL calculated by the controller 20 may deviate from the actual value. When the estimated value of the actual intake air amount KL deviates from the actual value, it becomes impossible to appropriately adjust the shaft torque TE of the engine 11 by retarding the ignition timing. In other words, if the valve timing suddenly changes during the torque replacement control, the actual intake air amount KL will also change suddenly, making it difficult to accurately predict the shaft torque TE of the engine 11. As a result, it becomes impossible to appropriately compensate for the decrease in the shaft torque TE by increasing the MG torque TMG, and the torque transmitted to the wheels 16 fluctuates, possibly deteriorating drivability.

The dashed lines of parts (A) and (D) in FIG. 4 show a comparative example in which the target intake valve timing VTI and target exhaust valve timing VTE are set to the base values VTIB and VTEB even during the torque replacement control. In part (A) in FIG. 4, changes in the actual intake air amount KL in the comparative example are indicated by a dashed line. Further, in part (D) in FIG. 4, changes in the shaft torque TE of the engine 11 in the comparative example are indicated by a dashed line. In the comparative example, the actual intake air amount KL and the shaft torque TE temporarily increase immediately after the start of the torque replacement control due to the sudden decrease in the valve overlap amount.

In contrast, the controller 20 of the present embodiment sets the value of the target intake valve timing VTI to the gradual change value VTISM of the base value VTIB during the torque replacement control. Further, the controller 20 sets the value of the target exhaust valve timing VTE to the gradual change value VTESM of the base value VTEB during the torque replacement control. Accordingly, the controller 20 decreases the change rate at which the valve timing is changed during the torque replacement control. As a result, torque fluctuations during the torque replacement control are suppressed by avoiding sudden changes in the actual intake air amount KL that accompany changes in the valve timing.

If the change rate of the valve timing during the torque replacement control is thus limited, the valve overlap amount may become excessive when the actual intake air amount KL decreases. This may cause combustion failure such as misfire. Regarding this, the controller 20 calculates the maximum overlap amount OLMAX, which is the maximum value of the valve overlap amount that can avoid poor combustion, based on the actual intake air amount KL. The controller 20 gradually changes the target intake valve timing VTI and the target exhaust valve timing VTE during the torque replacement control within a range in which the valve overlap amount is equal to or less than the maximum overlap amount OLMAX. That is, the change rate of the valve timing is made smaller during the torque replacement control within the above range. Thus, poor combustion of the engine 11 during the torque replacement control is less likely to occur.

The above-described embodiment achieves the following advantages.

(1) During the torque replacement control, the controller 20 predicts the shaft torque TE of the engine 11 and compensates for the decrease in the shaft torque TE of the engine 11 using the motor generator 13, thereby suppressing fluctuations in the torque transmitted to the wheels 16. During the torque replacement control, the controller 20 of this embodiment makes the change rate of the valve timing changed by the intake VVT 26 and the exhaust VVT 27 smaller than that during the normal engine control. Thus, a sudden change in the actual intake air amount KL due to the change in valve timing is less likely to occur. This facilitates accurate prediction of the shaft torque TE during the torque replacement control. As a result, the shaft torque TE of the engine 11 during the torque replacement control is smoothly decreased. Thus, it is possible for the motor generator 13 to properly compensate for the decrease in the shaft torque TE. Accordingly, the controller 20 of the present embodiment achieves an advantage of suppressing the torque fluctuations during the torque replacement control.

(2) The controller 20 of the present embodiment decreases the change rate of the valve timing during the torque replacement control within the range where the valve overlap amount is equal to or less than the maximum overlap amount OLMAX set according to the actual intake air amount KL. Thus, poor combustion of the engine 11 during torque replacement control is less likely to occur.

The present embodiment can be implemented with the following modifications. The present embodiment and the following modified examples can be implemented in combination with each other within a technically consistent range.

The engine 11 in the above embodiment includes the two variable valve mechanisms, the intake VVT 26 and the exhaust VVT 27. However, this is merely an example. Alternatively, the engine 11 may have only one of the intake VVT 26 and the exhaust VVT 27.

In the above embodiment, the gradual change value VTISM is set to the moving average value of the base value VTIB calculated by expression (1). Also, the gradual change value VTESM is set to the moving average value of the base value VTEB calculated by expression (2). However, this is merely an example. The method of calculating the gradual change values VTISM and VTESM based on the base values VTIB and VTEB is not limited to the method of the above embodiment.

In the above embodiment, the intake valve timing at which the valve timing overlap amount is the maximum overlap amount OLMAX with respect to the gradual change value VTESM is obtained as the value of the guard value VTIOLMAX. Then, the value of the target intake valve timing VTI is set to the valve timing on the retarded side from the gradual change value VTISM and the guard value VTIOLMAX, thereby suppressing poor combustion. That is, in the above embodiment, the guard value VTIOLMAX of the target intake valve timing VTI is set based on the gradual change value VTESM of the target exhaust valve timing VTE. Instead of the above embodiment, a configuration described below is also possible. The guard value of the target exhaust valve timing VTE may be set based on the gradual change value VTISM of the target intake valve timing VTI. That is, the exhaust valve timing at which the valve overlap amount becomes the maximum overlap amount OLMAX when the intake valve timing is set to the gradual change value VTISM may be calculated as the value of the guard value. The value of the target exhaust valve timing VTE may be set to a value indicating a more advanced valve timing from the gradual change value VTESM and the guard value. This maintains an amount of valve overlap that avoids poor combustion during the torque replacement control.

The calculation of the maximum overlap amount OLMAX from the actual intake air amount KL and the guard process of the target valve timing based on the maximum overlap amount OLMAX may be omitted. For example, the processes of steps S140 and S150 in FIG. 3 may be omitted, and the value of the target exhaust valve timing VTE may be set to the gradual change value VTESM in step S160.

In the embodiment described above, the controller 20 includes the CPU 21 and the ROM 22, and executes software processing. However, this is only an example. For example, the controller 20 may include a dedicated hardware circuit (e.g. ASIC) that processes at least part of the software processing executed in the above embodiment. That is, the controller 20 may have any of the following configurations (a) to (c). (a) The controller 20 includes a processing device that executes all processing according to the program, and a program storage device such as a ROM that stores the program. That is, the controller 20 includes a software execution device. (b) The controller 20 includes a processing device that executes a part of processing according to a program and a program storage device. In addition, the controller 20 has a dedicated hardware circuit to execute the rest of the processing. (c) The controller 20 is equipped with a dedicated hardware circuit that executes all processing. There may be a plurality of software execution devices and/or dedicated hardware circuits. That is, the processing may be executed by processing circuitry including at least one of the software execution devices or the dedicated hardware circuits. There may be a plurality of software execution devices and dedicated hardware circuits included in the processing circuitry. A program storage device or computer-readable medium includes any available medium accessible by a general purpose or dedicated computer.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A controller for a hybrid electric vehicle including an engine including a variable valve mechanism configured to variably set valve timing of an engine valve, a motor generator, a clutch configured to couple the engine to the motor generator, wherein the engine and the motor generator are driving sources for traveling, and the engine is configured to be connected to a wheel via the clutch and the motor generator,
the controller comprises processing circuitry,
traveling modes of the hybrid electric vehicle include a first traveling mode in which the hybrid electric vehicle travels with the clutch engaged and the engine operating, and a second traveling mode in which the hybrid electric vehicle travels with the clutch disengaged and the engine being stopped,
the processing circuitry is configured to execute a torque replacement control that decreases a shaft torque of the engine to 0 and increases a torque of the motor generator in accordance with the decreased shaft torque when switching from the first traveling mode to the second traveling mode,
the processing circuitry is configured to cause a change rate at which the valve timing is changed by the variable valve mechanism to be smaller during the torque replacement control than during a normal engine control, and configured to disengage the clutch after executing the torque replacement control.

2. The controller according to claim 1, wherein
the processing circuitry is configured to cause the change rate at which the valve timing is changed to decrease during the torque replacement control within a range in which an amount of valve overlap of an intake valve and an exhaust valve of the engine is equal to or less than a maximum value set according to an intake air amount of the engine.

3. A control method for a hybrid electric vehicle including an engine including a variable valve mechanism configured to variably set valve timing of an engine valve, a motor generator, a clutch configured to couple the engine to the motor generator, wherein the engine and the motor generator are driving sources for traveling, and the engine is configured to be connected to a wheel via the clutch and the motor generator,
traveling modes of the hybrid electric vehicle include a first traveling mode in which the hybrid electric vehicle travels with the clutch engaged and the engine operating, and a second traveling mode in which the hybrid electric vehicle travels with the clutch disengaged and the engine being stopped,
the control method comprises:
executing a torque replacement control that decreases a shaft torque of the engine to 0 and increases a torque of the motor generator in accordance with the decreased shaft torque when switching from the first traveling mode to the second traveling mode,
causing a change rate at which the valve timing is changed by the variable valve mechanism to be smaller during the torque replacement control than during a normal engine control, and
disengaging the clutch after executing the torque replacement control.
